(19) United States
(12) Patent Application Publication
(10) Pub. No.: US 2024/0133357 A1
(43) Pub. Date: Apr. 25, 2024

(54) SYSTEM FOR ALTERING FLOW OF LIQUIDS AND METHOD

(71) Applicant: Ayman Shata, Schaumburg, IL (US)

(72) Inventor: Ayman Shata, Schaumburg, IL (US)

(21) Appl. No.: 18/537,599

(22) Filed: Dec. 12, 2023

Related U.S. Application Data
(63) Continuation-in-part of application No. 17/245,796, filed on Apr. 30, 2021.
(60) Provisional application No. 63/081,610, filed on Sep. 22, 2020.

(51) Int. Cl. F03B 17/06; F03B 13/26

(52) U.S. Cl. CPC F03B 17/06; F03B 13/26; F05B 2220/32; F05B 2220/706

(57) ABSTRACT

A system for altering the flow of liquids is provided for altering flow properties of a liquid using a system of pathways organized in sections of varying properties. The system for altering the flow of liquids may include a basin section, thruster component, alteration section, flow section, turbine section, conveyance section, first pathway, second pathway and liquid-driven turbine. A method for altering flow properties of a liquid using a system of pathways organized in sections of varying properties using the system for altering the flow of liquids is also provided.

### CROSS-REFERENCE TO RELATED APPLICATION

This application is a continuation-in-part which claims the priority from U.S. non-provisional patent application Ser. No. 17/245,796 filed Apr. 30, 2021. The foregoing application is incorporated in its entirety herein by reference.

### FIELD OF THE INVENTION

The present disclosure relates to a system for altering flow of liquids. More particularly, the disclosure relates to altering flow properties of a liquid using a system of pathways organized in sections of varying properties.

### BACKGROUND

Hydroelectrical systems may utilize tidal energy or other energy of liquids in motion which is configured to convert energy from the tides particularly in large bodies of liquid. For one of these systems to harvest energy from tides, turbines are installed underwater to harvest tidal power resulting in the tidal power being converted into mechanical energy. However, there are multiple drawbacks to current systems. For example, installation and maintenance of the turbines along with the high respective costs render the systems difficult to implement on a large scale. Furthermore, integrating these systems poses a significant risk to the marine ecosystem and overall marine life preservation.

Additionally, in most configurations, hydroelectrical systems require near-perfect conditions, such as the ideal flow properties, to capture the energy from the liquid. In order to create these near-perfect conditions to alter the flow properties of the liquid, dams are installed, which disrupt the overall marine ecosystem. Thus, implementation of the hydroelectrical systems can sometimes require relocation of both terrestrial and aquatic communities, adding to the economical toll associated with integrating such complex systems. However, one of the largest drawbacks of current hydroelectrical systems is the inability to control the flow properties necessary to power the turbines.

Therefore, a need exists to solve the deficiencies present in the prior art. What is needed is a system to alter the flow properties of a liquid. What is needed is a system to accelerate a liquid to more efficiently drive a turbine. What is needed is a system of varying pathways to control the flow of a liquid. What is needed is a system to condition a liquid to drive a turbine. What is needed is a system to increase the efficacy of a liquid-driven turbine connected to external equipment.

### SUMMARY

An aspect of the disclosure advantageously provides a system to alter the flow properties of a liquid. An aspect of the disclosure advantageously provides a system to accelerate a liquid to more efficiently drive a turbine. An aspect of the disclosure advantageously provides a system of varying pathways to control the flow of a liquid. An aspect of the disclosure advantageously provides a system to condition a liquid to drive a turbine. An aspect of the disclosure advantageously provides a system to increase the efficacy of a liquid-driven turbine connected to external equipment.

According to an embodiment of this disclosure, a system for altering flow properties of liquids is provided, which may include a basin section and an alteration section. The basin section may supply a liquid for the system. The basin section may include an origin basin section port and an exit basin section port located apart from the origin basin section port. The alteration section may alter the flow properties. The alteration section may include a flow section to receive the liquid from the basin section, which may further include an origin flow section end and an exit flow section end opposite to the origin flow section end. The alteration section may also include a turbine section to receive the liquid from the flow section, which may further include an origin turbine section end and an exit turbine section end opposite to the origin turbine section end. The alteration section may further include a conveyance section to receive the liquid from the turbine section, which may further include an origin conveyance section end and an exit conveyance section end opposite to the origin conveyance section end. A thruster component may be provided comprising at least one thruster to accelerate the liquid. A liquid-driven turbine may be provided through which at least part of the liquid may pass. The liquid that passes from the exit basin section port of the basin section may be flowed through the alteration section and directed to the basin section via the origin basin section port.

In another aspect, the exit flow section end of the flow section may be substantially sealed to the origin turbine section end of the turbine section. Additionally, the exit turbine section end of the turbine section may be substantially sealed to the origin conveyance section end of the conveyance section.

In another aspect, the exit basin section port of the basin section may be substantially sealed to the origin flow section end of the flow section. Additionally, the exit conveyance section end of the conveyance section may be substantially sealed to the origin basin section port of the basin section.

In another aspect, the basin section may provide at least one portion of ingress and/or egress to regulate at least part of the liquid accessible to the alteration section.

In another aspect, the basin section may comprise a reservoir to receive the liquid via the origin basin section port. Additionally, the thruster component may be operatively attached to the exit basin section port to draw the liquid via the reservoir and accelerate the liquid to enter the alteration section at a first flow rate.

In another aspect, the at least one thruster may receive at least part of its power from an external power source to accelerate the liquid to the first flow rate.

In another aspect, a first pathway having a first pathway cross-sectional area may flow the liquid through the flow section at a first flow rate. Additionally, a second pathway having a second pathway cross-sectional area smaller than the first pathway cross-sectional area may flow the liquid through the conveyance section at a second flow rate.

In another aspect, the thruster component may be operatively attached to the origin flow section end of the flow section to draw the liquid via the basin section and accelerate the liquid through the alteration section at a first flow rate.

In another aspect, a first pathway having a first pathway cross-sectional area may terminate at a reduction section located within the turbine section through which the liquid may flow at a first flow rate. Additionally, a second pathway having a second pathway cross-sectional area may originate from the reduction section through which the liquid may flow at a second flow rate. Also, the first pathway cross-sectional area may be reduced to the second pathway cross-sectional area by the reduction section such that the liquid is accelerated from the first flow rate to the second flow rate. Furthermore, the reduction section may be substantially sealed between the first pathway and the second pathway.

In another aspect, the liquid-driven turbine may be located inside the second pathway and attached to a generator. Additionally, the liquid-driven turbine may be rotated by the liquid having the second flow rate to drive the generator.

In another aspect, an air vent may be located between the thruster component and the reduction section to release air trapped within the alteration section.

In another aspect, the origin of the basin section port may be positioned at a lower height than the exit basin section port. Additionally, at least part of the alteration section may have a downward grade from the exit basin section port to the origin basin section port.

In another aspect, the thruster component may comprise a plurality of thrusters, each of which being aligned to a common thruster output plane. Additionally, the liquid that may be accelerated by the plurality of thrusters may be discharged approximately perpendicular to the common thruster output plane.

In another aspect, the basin section, the flow section, the turbine section, and the conveyance section may be provided as a single continuous unit.

According to an embodiment of this disclosure, a system for altering flow properties of liquids is provided, which may include a basin section and an alteration section. The basin section may supply a liquid for the system. The basin section may include an origin basin section port and an exit basin section port located in a vertically lower plane from the origin basin section port. The alteration section may alter the flow properties. The alteration section may include a flow section to receive the liquid from the basin section, which may further include an origin flow section end and an exit flow section end opposite to the origin flow section end. The alteration section may also include a turbine section to receive the liquid from the flow section, which may further include an origin turbine section end and an exit turbine section end opposite to the origin turbine section end. The alteration section may further include a conveyance section to receive the liquid from the turbine section, which may further include an origin conveyance section end and an exit conveyance section end opposite to the origin conveyance section end. In one embodiment, the alteration section may be nonlinear while having a general downward angle. A thruster component may be provided comprising at least one thruster to accelerate the liquid. A liquid-driven turbine may be provided through which at least part of the liquid may pass. The liquid that passes from the exit basin section port of the basin section may be flowed through the alteration section and directed to the basin section via the origin basin section port.

According to an additional embodiment of this disclosure, a system for altering flow properties of liquids is provided, which may include a basin section to supply a liquid for the system, an origin basin section port, and an exit basin section port located apart from the origin basin section port. Additionally, the system may include an alteration section to alter the flow properties comprising a flow section to receive the liquid from the basin section, a turbine section to receive the liquid from the flow section, a conveyance section to receive the liquid from the turbine section, and a thruster component comprising at least one thruster to accelerate the liquid. Also, the system may include a first tube having a first tube cross-sectional area which may flow the liquid through the flow section at a first flow rate, and a second tube having a second tube cross-sectional area which may be smaller than the first tube cross-sectional area which may flow the liquid through the conveyance section at a second flow rate. Furthermore, the liquid that passes from the exit basin section port of the basin section may be flowed through the alteration section and directed to the basin section via the origin basin section port.

In another aspect, the system may include a liquid-driven turbine through which at least part of the liquid passes. Additionally, the liquid-driven turbine may be located inside the second tube and attached to a generator. Additionally, the liquid-driven turbine may be rotated by the liquid having the second flow rate to drive the generator.

In another aspect, the thruster component may comprise a plurality of thrusters, each of which being aligned to a common thruster output plane. Additionally, the liquid that may be accelerated by the plurality of thrusters may be discharged approximately perpendicular to the common thruster output plane.

According to an embodiment of this disclosure, a method is provided for altering flow properties of liquids. The method may include (a) drawing a liquid via a basin section to supply a liquid to an alteration section. The method may also include (b) altering the flow properties of the liquid passing through an alteration section. Step (b) of this method may further include (i) receiving the liquid from the basin section to flow through a flow section, (ii) receiving the liquid from the flow section to flow through a turbine section, and (iii) receiving the liquid from the turbine section to flow through a conveyance section. The method may further include (c) accelerating the liquid via a thruster component comprising at least one thruster. The method may further include (d) passing at least part of the liquid through a liquid-driven turbine. The liquid that passes from the exit basin section port of the basin section may be flowed through the alteration section and directed to the basin section via the origin basin section port.

In another aspect, the method may additionally include during step (a), flowing the liquid in a first pathway having a first pathway cross-sectional area at a first flow rate. The method may also include, before the operation of step (d), reducing the first pathway cross-sectional area to the second pathway cross-sectional area by a reduction section such that the liquid is accelerated from the first flow rate to a second flow rate. The method may also include, during the operation of step (d), the liquid passing over the liquid-driven turbine at the second flow rate.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a top plan view of a system for altering flow properties of liquids, according to an embodiment of this disclosure.

FIG. 2 is a top plan view of a system for altering flow properties of liquids, according to an alternative embodiment of this disclosure.

FIG. 3 is a top plan view of a system for altering flow properties of liquids, according to an alternative embodiment of this disclosure.

FIG. 4 is a top plan view of a system for altering flow properties of liquids, according to an alternative embodiment of this disclosure.

FIG. 5 is a perspective view of a feature for exhausting undesired air, according to an embodiment of this disclosure.

FIG. 6 is a perspective view of a feature provided for exhausting undesired air, according to an alternative embodiment of this disclosure.

FIG. 7 is a top plan view of a system for altering flow properties of liquids, according to an alternative embodiment of this disclosure.

FIG. 8 is a side elevation view of a turbine section, according to an embodiment of this disclosure.

FIG. 9 is a perspective view of a thruster, according to an embodiment of this disclosure.

FIG. 10 is a front elevation view of a thruster component aligned on a common thruster output plane, according to an embodiment of this disclosure.

FIG. 11 is a perspective view of a feature provided for increasing the flow rate, according to an alternative embodiment of this disclosure.

FIG. 12 is a block diagram of an illustrative computerized device on which aspects of a system enabled by this disclosure may be operated, according to an embodiment of this disclosure.

FIG. 13 is a flow chart view of a method of using the system for altering flow properties of liquids, according to an embodiment of this disclosure.

FIG. 14 is a flow chart view of an additional embodiment of a method of using the system for altering flow properties of liquids, according to an alternative embodiment of this disclosure.

FIG. 15 is a side elevation view of a system for altering flow properties of liquids being at least partially angled, according to an embodiment of this disclosure.

### DETAILED DESCRIPTION

The following disclosure is provided to describe various embodiments of a system for altering the flow of liquids. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of at least one element in that group, which may be included with other elements of the group. All numbers, measurements, and values are given as approximations unless expressly stated otherwise.

For the purpose of clearly describing the components and features discussed throughout this disclosure, some frequently used terms will now be defined, without limitation. The term flow properties, as it is used throughout this disclosure, is defined as the properties of the liquid, including, but not limited to, velocity, acceleration, and other properties that would be appreciated by those of skill in the art. The term liquid, as it is used throughout this disclosure, is defined as a substance that has no independent shape but has a definite volume and does not expand indefinitely and is essentially incompressible, for example, water.

The term air, as it is used throughout this disclosure, is defined as a mixture of gases that may exist in the system. The term thruster, as it is used throughout this disclosure, is defined as a propulsive device, for example, a device for accelerating the flow of a liquid. The term reservoir, as it is used throughout this disclosure, is defined as a place where liquid can be inputted, outputted, and/or stored. The term pathway, as it is used throughout this disclosure, is defined as a path along which liquids may flow. The term tube, as it is used throughout this disclosure, is defined as a hollow and substantially enclosed pathway which is capable of guiding liquids.

The term turbine, as it is used throughout this disclosure, is defined as a rotary mechanical device that extracts energy from a liquid flow property and converts it into rotational motion that can be useful for performing work. The term common thruster output plane, as it is used throughout this disclosure, is defined as a plane in which a plurality of thruster components is aligned on to expel liquid approximately perpendicular to the plane. The term reduction section, as it is used throughout this disclosure, is defined as a segment which assists in transitioning from one pathway cross-sectional area to another pathway cross-sectional area. The term junction, as it is used throughout this disclosure, is defined as a place or point of meeting of two or more ends.

Additionally, as would be appreciated by those of skill in the art, any examples, given in the context of using water as a liquid, would be extendable by replacing and/or supplementing the water with another liquid, without limitation.

Further, as would be appreciated by those of skill in the art, any examples, given in the context of liquid flowing through the basin section and through the alteration section, would be extendable to be understood as substantially all the liquid flowing through those sections. As understood by those of skill in the art, the sections may be substantially sealed, however, inclusion of undesired leaking of liquid at any point throughout the system is intended to be within the scope of being substantially sealed, without limitation.

Various aspects of the present disclosure will now be described in detail, without limitation. In the following disclosure, a system for altering the flow of liquids will be discussed. Those of skill in the art will appreciate alternative labeling of the system for altering the flow of liquids as a flow altering system, liquid control system for turbine application, fluid accelerating system for enhanced mechanical application, fluid turbine system, the invention, or other similar names. Similarly, those of skill in the art will appreciate alternative labeling of the system for altering the flow of liquids as a method for altering the flow properties and work capacity of a liquid, liquid adaptation method, flow alteration method, liquid conditioning technique, method, operation, the invention, or other similar names. Skilled readers should not view the inclusion of any alternative labels as limiting in any way.

This disclosure provides illustrative embodiments that improve upon the problems with the prior art by describing a system for altering the flow properties of liquids and methods associated with the system configured to utilize components such as generators and tidal power in an eco-friendly and economically sustainable manner that may support flexible installation, easy maintenance, reduction of a CO₂ footprint, and promotes preservation of marine life and marine ecosystems. In particular, the disclosure provides illustrative embodiments describing a combination of power sources, turbines, thrusters, and communicative couplings of these components to assist with controlling quantities and flows of liquid in hydroelectrical systems, without limitation.

In at least one embodiment, a system to alter the flow properties of liquids is disclosed. The system may comprise a basin section and an alteration section. The alteration section may comprise additional sections, such as a reduction section to reduce the pathway from one pathway cross-sectional area to another pathway cross-sectional area. The alteration section may further include a thruster component which may be powered by a power source. The liquid may flow through the alteration section to alter the flow properties of the liquid, for example, increasing the velocity of the liquid.

In various embodiments, a system to alter the flow properties of liquids is disclosed, without limitation. The system may include a basin section, a flow section, a turbine section, and a conveyance section. In at least one embodiment, the thruster component may be included in the basin section and/or the flow section. The system may include a thruster component capable of increasing the liquid from the basin section to a first flow rate. The liquid at the first flow rate may flow through the flow section. An air vent may be located in the alteration section to release gases throughout or above the liquid. The liquid at the first flow rate may increase its speed to a second flow rate while flowing through the reduction section. The liquid at a second flow rate may rotate the liquid-driven turbine blades to produce mechanical energy which may be converted to electrical energy in a generator. The liquid at a second flow rate may be returned to the basin section via the conveyance section. In one embodiment, the basin section may optionally include at least one portion of ingress and/or egress for liquid from outside the system to enter and/or exit the basin section which may be used in the alteration section.

The systems and methods enabled by this disclosure may allow a mechanically assisted water current provided by the thruster component to modify liquid flow. This liquid may possess enough force to turn liquid-driven turbine blades, resulting in electricity being generated. In some examples, the generated electricity may be transmitted to external power grids, stored in a power storage component such as a battery, and/or otherwise be used in a manner that will be appreciated by a person of skill in the art. A system enabled by the present disclosure may facilitate a cycle of liquid flow powered by speed controlling thruster components and a reduction section, for example being conical in shape, supported by one or more reservoirs ensuring that liquid may be approximately continuously directed into the path of the alteration section. In one embodiment, the liquid may be cycled throughout the system.

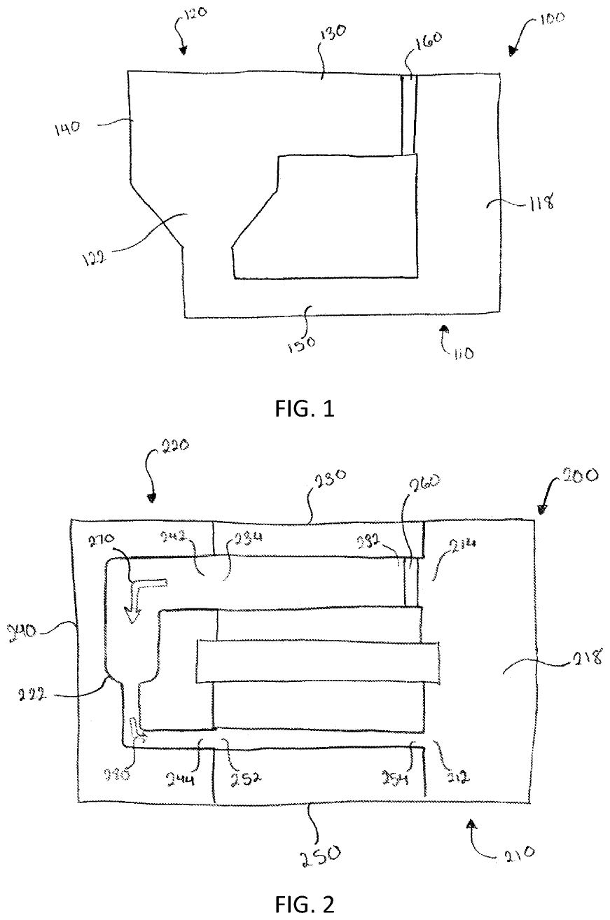

Referring now to FIG. 1, an exemplary system for altering flow properties of liquids is shown. An exemplary embodiment of a system 100 enabled by this disclosure configured in a closed-loop configuration will now be discussed, without limitation. In this embodiment, the system 100 may be fully enclosed. In general, the system may comprise a basin section 110 and an alteration section 120. A reservoir 118 may be included in the basin section 110. A thruster component 160 may receive liquid from the reservoir 118. The liquid may flow through the flow section 130, then the turbine section 140, and through the reduction section 122. The liquid may be transported from the reduction section 122, through the conveyance section 150, and into the reservoir 118.

In one illustrative embodiment, the alteration section 120 may include additional sections. For example, the system 100 may include a basin section 110, thruster component 160, flow section 130, turbine section 140, reduction section 122, conveyance section 150, reservoir 118, and additional components that will be discussed in greater detail below. The system 100 may operate at least one of these components interactively with other components for generation of electrical power, such as using a hybrid system, to promote increased efficiency.

The reservoir will now be discussed in greater detail. FIGS. 1-4 and 7 highlight examples of the reservoir 118, 218, 318, 418, 718, 1518, which may also be shown in other figures. In some embodiments, the basin section 110, 210, 310, 410, 710, 1510, in which the reservoir 118, 218, 318, 418, 718, 1518 may be located in, includes an origin basin section port 212, 312, 1512 and an exit basin section port 214, 314, 1514. The origin basin section port 212, 312, 1512 may be used for entrance into the alteration section 120, 220, 320, 420, 720, 1520. The exit basin section port 214, 314, 1514 may be used for exiting from the alteration section 120, 220, 320, 420, 720, 1520. The basin section 110, 210, 310, 410, 710, 1510 may be configured to be in an open loop or a closed loop system. In at least one embodiment, the basin section 110, 210, 310, 410, 710, 1510 may further include a portion of ingress and/or egress 416 to allow for outside sources of liquid flow to and from the reservoir 118, 218, 318, 418, 718, 1518 to create an open loop system.

In some embodiments, the basin section 110, 210, 310, 410, 710, 1510 may allow for liquid egress and/or ingress 416 from an outside source. As appreciated by those of skill in the art, the liquid inside the system may include liquid from an outside source, liquid from inside the system, a combination of the two, and/or any other applicable body of liquid configuration in a contained or uncontained environment, as would be appreciated by those of skill in the art after having the benefit of this disclosure. In a closed-loop configuration, the liquid may circulate from the exit basin section port 214, 314, 1514, of the basin section 110, 210, 310, 410, 710, 1510, through the alteration section 120, 220, 320, 420, 720, 1520 to the origin basin section port 212, 312, 1512, of the basin section 110, 210, 310, 410, 710, 1510. In an open-loop configuration, the liquid may circulate from within and outside of the system 100, 200, 300, 400, 700, 1500.

In some open-loop embodiments, the liquid source may be a naturally flowing water source, such as an ocean, river, stream, bay, and/or other sources. In other open water embodiments, the liquid source may be a man-made flowing water source, such as a dam, pool, holding pond, and/or other sources. In some embodiments, open water sources may be separate from but still communicate with basin section 110, 210, 310, 410, 710, 1510. In other embodiments, the liquid source may also be contained in a single tank and/or reservoir, or in multiple tanks and/or reservoirs.

In either open-loop or closed-loop embodiments, at least one of the reservoirs 118, 218, 318, 418, 718, 1518 may include at least one stability wall configured to be structurally capable of resisting the pressure applied by the applicable internal and external body of water associated with the system 100, 200, 300, 400, 700, 1500.

In some embodiments, the origin flow section end 232, 332, 532 may be designed and allocated respective to the size of a thruster component 160, 260, 360, 460, 760, 1060, 1560 to accommodate the volume of liquid desired by the user. For example, and without limitation, a desired rate at which the thruster component may rotate may include a rate with high or optimal operational efficiency.

Accordingly, in various embodiments, liquid may past through the basin section 110, 210, 310, 410, 710, 1510, and discharge liquid at a first flow rate 172 towards the thruster component 160, 260, 360, 460, 760, 1060, 1560, whereby the thruster component 160, 260, 360, 460, 760, 1060, 1560 can discharge liquid at another flow rate higher than the first flow rate 172. In one embodiment, provided without limitation, a relational formula that considers velocity and area may be applied such as V1*A1=V2*A2. In some embodiments, the output flow rate may be based on a relationship between an input diameter and an output diameter, as will be appreciated by those of skill in the art. As examples, provided without limitation, a ratio of the entry flow rate to the first flow rate may be from about 2 meters per second (m/s) to about 6 m/s, or from about 2 m/s to about 8 m/s, or from about 4 m/s to about 10 m/s.

The alteration section will now be discussed in greater detail. FIGS. 1-4, and 7 highlight examples of the alteration section 120, 220, 320, 420, 720, 1520, which may also be shown in other figures.

The alteration section 120, 220, 320, 420, 720, 1520 may be attached to the basin section 110, 210, 310, 410, 710, 1510. The alteration section 120, 220, 320, 420, 720, 1520 may be comprised of the flow section 130, 230, 330, 430, 530, 730, 1530, the turbine section 140, 240, 340, 440, 740, 1140, 1540, and the conveyance section 150, 250, 350, 450, 650, 750, 1550. The alteration section 120, 220, 320, 420, 720, 1520 may further include a thruster component 160, 260, 360, 460, 760, 1060, 1560, a liquid-driven turbine 1146 and/or a reduction section 122, 222, 722, 1122, 1522. The flow section 130, 230, 330, 430, 530, 730, 1530 may include an origin flow section end 232, 332, 532, and an exit flow section end 234, 334, 534. The turbine section 140, 240, 340, 440, 740, 1140, 1540 may include an origin turbine section end 242, 342 and an exit turbine section end 244, 344. The conveyance section 150, 250, 350, 450, 650, 750, 1550 may include an origin conveyance section end 252, 352, 652, and an exit conveyance section end 254, 354, 654. The thruster component 160, 260, 360, 460, 760, 1060, 1560 may include at least one thruster 962, 1062, with one or more thruster blades 966 which may lie on a common thruster output plane 1064. The thruster component may also be operatively attached to a power source 464. The liquid-driven turbine 1146 may be operatively attached to a generator 1148. The liquid may rotate the liquid-driven turbine 1146 to produce mechanical energy which may be converted to electrical energy in a generator 1148.

Referring now to FIG. 2, an exemplary system for altering flow properties of a liquid is shown. An exemplary embodiment of a system 200 enabled by this disclosure configured in a closed-loop configuration will now be discussed, without limitation. In this embodiment, the system 200 may be fully enclosed. In general, the system may include a basin section 210 and an alteration section 220. The liquid may generally flow from the basin section 210, through the alteration section 220. While in the alteration section 220, the flow rate of the liquid may be altered from a first flow rate to a second flow rate, after which the liquid may be used to perform work and may return to the basin section 210.

In one example, a system for altering flow properties of liquids enabled by this disclosure will be provided in the context of the illustration provided in FIG. 2, without limitation. The flow of the liquid may begin from a basin section 210. For example, the liquid may flow from the basin section 210 through an exit basin section port 214 into the origin flow section end 232 of the flow section 230. A thruster component 260 may be located in the alteration section 220, for example, at the origin flow section end 232 of the flow section 230. The flow section 230 may further comprise a first pathway 270. The first pathway 270 of the flow section 230 may extend from the origin flow section end 232 to the exit flow section end 234. In one illustrative embodiment, the thruster component 260 may be located at least partially within flow section 230, for example at the origin flow section end 232 of the flow section 230. The liquid may be accelerated by the thruster component 260 and may leave the flow section 230 at the exit flow section end 234.

The flow of the liquid from the flow section 230 may be received by the turbine section 240. The flow section 230 may be attached to the turbine section 240, for example, at the junction of the exit flow section end 234 and an origin turbine section end 242. The first pathway 270 may continue from the flow section 230 and through at least part of the turbine section 240. The turbine section 240 may further include a reduction section 222. The liquid may continue to flow along the first pathway 270 until being received by the reduction section 222. The reduction section 222 may be attached to the first pathway 270. The reduction section 222 may change the size of a pathway, for example, by decreasing the first cross-sectional area to a second cross-sectional area. Another pathway, for example, the second pathway 280 may flow through the turbine section 240. The reduction section 222, described later in greater detail, may assist in reduction from one pathway to another pathway, for example, from the first pathway 270 to the second pathway 280. The second pathway 280 may guide liquid through the turbine section until exiting, for example, at the exit turbine section end 244.

The flow of the liquid from the turbine section 240 may be received by the conveyance section 250. The turbine section 240 may be attached to the conveyance section 250, for example, at the junction of the exit turbine section end 244 and an origin conveyance section end 252. The second pathway 280 may continue to flow liquid from at least part of the turbine section 240 and through at least part of the conveyance section 250. The liquid may flow via the second pathway 280 of the conveyance section 250, for example, from the origin conveyance section end 252 to the exit conveyance section end 254. The liquid may be received by the basin section 210 of the origin basin section port 212. The origin basin section port 212 may be substantially sealed to the exit conveyance section end 254.

The flow section will now be discussed in greater detail. FIGS. 1-5 and 7 highlight an example of the flow section 130, 230, 330, 430, 530, 730, 1530, which may also be shown in other figures.

In various embodiments, the flow section 130, 230, 330, 430, 530, 730, 1530 may have an origin flow section end 232, 332, 532, and an exit flow section end 234, 334, 534. At least one flow section 130, 230, 330, 430, 530, 730, 1530 may be shaped and sized to serve as an entrance for the liquid to enter from the basin section 110, 210, 310, 410, 710, 1510. In at least one embodiment, the flow section may include the thruster component 160, 260, 360, 460, 760, 1060, 1560 to accelerate the liquid to a desired first flow rate.

According to embodiments, the origin flow section end 232, 332, 532 may be configured to be substantially sealed to the exit basin section port 214, 314, 1514. In some embodiments, the thruster component 160, 260, 360, 460, 760, 1060, 1560 may be located either at the origin flow section end 232, 332, 532 and/or at the exit basin section port 214, 314, 1514. In further embodiments, the thruster component 160, 260, 360, 460, 760, 1060, 1560 may be located in between both the origin flow section end 232, 332, 532, and the exit basin section port 214, 314, 1514.

The reduction section will now be discussed in greater detail. FIGS. 1, 2, 7, 8, and 11, highlight an example of the reduction section 122, 222, 722, 1122, 1522, which may also be shown in other figures.

In various embodiments, the reduction section 122, 222, 722, 1122, 1522 may include at least part of a first pathway 170, 270, 770, 1170, and at least part of a second pathway 180, 280, 780, 1180. In some embodiments, the reduction section 122, 222, 722, 1122, 1522 may change the size of one pathway's cross-sectional area to another pathway's cross-sectional area, for example, may decrease the first pathway 170, 270, 770, 1170 to the second pathway 180, 280, 780, 1180. In further embodiments, the first pathway 170, 270, 770, 1170 is larger than the second pathway 180, 280, 780, 1180. In additional embodiments, a ratio of the first pathway cross-sectional area 574, 1174 to the second pathway cross-sectional area 684, 1184, is from about 3 (square meters) m² to about 28 m², or from about 3 m² to about 50 m², or from about 12 m² to about 80 m². Those of skill in the art will appreciate the unlimited number of ratios of the first pathway cross-sectional area to the second pathway cross-sectional area.

In at least one embodiment, the reduction section 122, 222, 722, 1122, 1522 may increase the liquid flow rate between the first pathway 170, 270, 770, 1170 and the second pathway 180, 280, 780, 1180. For example, the increased speed of the first flow rate 172 in the first pathway 170, 270, 770, 1170 to the second flow rate 182 in the second pathway 180, 280 780, 1180 may be from about 1 m/s to 2 m/s, from about 2 m/s to 6 m/s, or from about 4 m/s to 10 m/s. Those of skill in the art will appreciate the unlimited amount of speed changes that may occur at the reduction section 122, 222, 722, 1122, 1522.

In various embodiments, the alteration section 120, 220, 320, 420, 720, 1520 may include a component to capture the energy from the accelerated liquid with increased efficacy. For example, this component may be a liquid-driven turbine 1146, located in the turbine section 140, 240, 340, 440, 740, 1140, 1540, which may produce mechanical energy to be converted into electrical energy in a generator 1148.

According to some embodiments, the exit conveyance section end 254, 354, 654 may be configured to be substantially sealed to the origin basin section port 212, 312, 1512. The origin recovery port 212, 312, 1512, of the basin section 110, 210, 310, 410, 710, 1510 may then include the liquid until it either leaves the system 100, 200, 300, 400, 700, 1500, or enters through the exit basin section port 214, 314, 1514 to flow through the alteration section 120, 220, 320, 420, 720, 1520.

The pathways will now be discussed in greater detail. FIGS. 2, 7, 8, and 11, highlight examples of a liquid flowing through at least one pathway, which may also be shown in other figures.

In at least one embodiment, two or more pathways, with different cross-sectional areas, may be located in the system 100, 200, 300, 400, 700, 1500, for example, in the alteration section 120, 220, 320, 420, 720, 1520. Each pathway is a path along which liquids may flow. A first pathway 170, 270, 770, 1170 may have a first pathway cross-sectional area 574, 1174. A second pathway 180, 280, 780, 1180 may have a second pathway cross-sectional area 684, 1184. Those skilled in the art would appreciate the existence of at least two pathways to harness the liquid's energy. In further embodiments, the first pathway 170, 270, 770, 1170 may transition with the second pathway 180, 280, 780, 1180 at a reduction section 122, 222, 722, 1122, 1522.

In at least one embodiment, liquid may be accelerated to drive a liquid-driven turbine in the system 100, 200, 300, 400, 700, 1500, at an optimal flow rate and velocity. A liquid may flow through the first pathway 170, 270, 770, 1170, and may enter a reduction section 122, 222, 722, 1122, 1522, which may exit into a second pathway 180, 280, 780, 1180. The velocity of the liquid in the first pathway 170, 270, 770, 1170 may be manipulated, for example, via a thruster component 160, 260, 360, 460, 760, 1060, 1560. The velocity of the liquid in the second pathway may be manipulated, for example, via a reduction section 122, 222, 722, 1122, 1522.

The velocity change via the reduction section 122, 222, 722, 1122, 1522 may be manipulated, for example, provided via a Bernoulli Effect. For example, the liquid may enter a reduction section 122, 222, 722, 1122, 1522 via the first pathway 170, 270, 770, 1170 and exit having a higher velocity at the exit point via the second pathway 180, 280, 780, 1180. This operation may be assisted by the thruster component 160, 260, 360, 460, 760, 1060, 1560, which may create an increased volume of liquid flowing into the reduction section 122, 222, 722, 1122, 1522 entrance of the turbine section 140, 240, 340, 440, 740, 1140, 1540 via the first pathway 170, 270, 770, 1170.

In some embodiments, the first pathway 170, 270, 770, 1170, the reduction section, and the second pathway 180, 280, 780, 1180 may be located in different liquid transportation systems such as channels, tubes, pipes, ducts, gutters, trenches, spillways, drains, canals, waterways, or any other liquid transportation system. Those of skill in the art will appreciate that the list of liquid transportation systems is not intended to be limited. Skilled artisans will appreciate additional examples of liquid transportation systems to be included by this disclosure, after having the benefit of this disclosure.

In some embodiments, the alteration section 120, 220, 320, 420, 720, 1520 may have at least one bend throughout the system. In further embodiments, at least one bend may be located in the turbine section 140, 240, 340, 440, 740, 1140, 1540. In additional embodiments, a bend may be located in the turbine section 140, 240, 340, 440, 740, 1140, 1540, near the junction of the turbine section 140, 240, 340, 440, 740, 1140, 1540, and the flow section 130, 230, 330, 430, 530, 730, 1530. In other embodiments, a bend may be located in the turbine section 140, 240, 340, 440, 740, 1140, 1540, near the junction of the turbine section 140, 240, 340, 440, 740, 1140, 1540, and the conveyance section 150, 250, 350, 450, 650, 750, 1550. In at least one embodiment, at least one bend throughout the system may assist with providing a compact system 100, 200, 300, 400, 700, 1500. As would be appreciated by those of skill in the art, any number of bends would be extendable throughout the system 100, 200, 300, 400, 700, 1500.

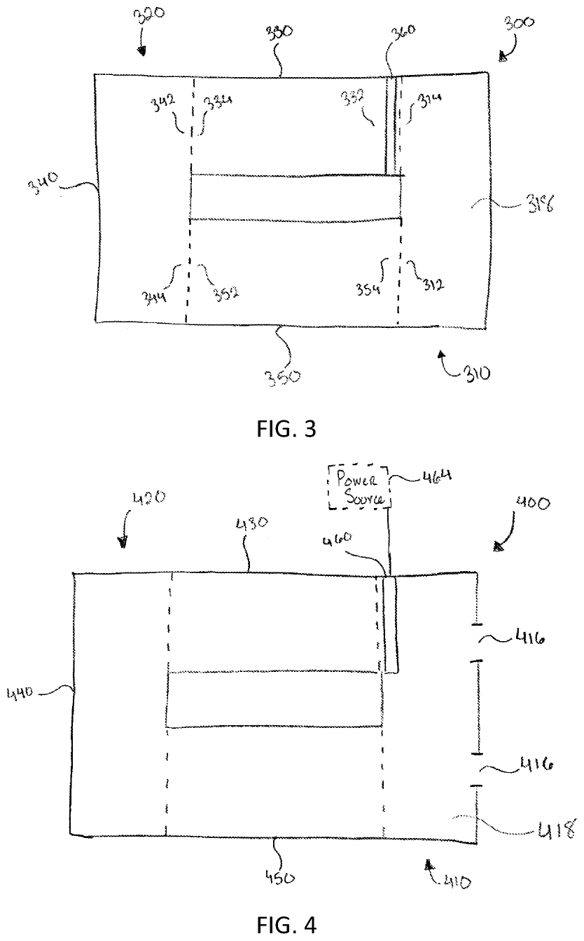

Referring now to FIG. 3, an exemplary system for altering flow properties of liquids is shown. An exemplary embodiment of system 300 enabled by this disclosure in a closed-loop configuration will now be discussed, without limitation. In this embodiment, the system 300 may be fully enclosed.

In general, the system may comprise a basin section 310, which may house a reservoir 318, and an alteration section 320. The liquid may generally flow from the basin section 310, through the alteration section 320, where the flow properties may be altered.

In one illustrative embodiment, the flow of the liquid may begin from the basin section 310. For example, the liquid may flow through the exit basin section port 314 and into the origin flow section end 332. A thruster component 360 may be located in the alteration section 320, for example, at the origin flow section end 332 of the flow section 330. The thruster component 360 may accelerate the liquid to a first flow rate. The accelerated liquid may travel through the exit flow section end 334 of the flow section 330 and may be received by the origin turbine section end 342 of the turbine section 340. The liquid may continue to flow through the turbine section 340. The liquid may travel through the exit turbine section end 344 of the turbine section 340 and may be received by the origin conveyance section end 352 of the conveyance section 350. The liquid may then flow through the exit conveyance section end 354 of the conveyance section 350. The liquid may be received by the origin basin section port 312 of the basin section 310. In additional embodiments, the basin section 310 may be substantially sealed to the flow section 330. The flow section 330 may be substantially sealed to the turbine section 340. The turbine section 340 may be substantially sealed to the conveyance section 350. The conveyance section 350 may be substantially sealed to the basin section 310.

Referring now to FIG. 4, an exemplary system for altering flow properties of liquids 400 is shown. An exemplary embodiment of system 400 enabled by this disclosure in an open-loop configuration will now be discussed, without limitation. In this embodiment, the system 400 may be fully open.

In general, the system may comprise a basin section 410, which may house a reservoir 418, and an alteration section 420. The liquid may generally flow from the basin section 410, through the alteration section, where the flow rate may be altered to a first flow rate.

In one illustrative embodiment, the flow of the liquid may begin from the basin section 410. The basin section 410 may include at least one portion of ingress and/or egress 416 which may be available for liquid outside the system 400 to enter or exit the system. A thruster component 460 may be included in the reservoir 418. The thruster component 460 may accelerate the liquid. The accelerated liquid may be received by the flow section 430. The flow section 430 may be substantially sealed to a turbine section 440. The accelerated liquid may continue to flow through the flow section 430 until it is received by the turbine section 440. The turbine section 440 may be substantially sealed to the conveyance section 450. The accelerated liquid may continue to flow through the turbine section 440 until it is received by the conveyance section 450. The conveyance section 450 may be substantially sealed to the basin section 410. The accelerated liquid may continue to flow through the conveyance section 450 until it is received by the reservoir 418 of the basin section 410.

In further embodiments of FIG. 4, the thruster component 460 may be configured to receive power from a power source 464. The power source 464 may be used in both open-loop and closed-loop configurations, without limitation. As would be appreciated by those skilled in the art, the power source 464 may provide power to any part of the system, for example, the thruster component 460. The power source 464 may provide virtually any amount of power, without limitation. For example, the thruster component 460 may receive less than all of its power from the power source 464. The external power source 464 may be, but not limited to, solar power, conventional hydro, natural gas, liquid natural gas, grid power, battery, wind power, and any other applicable power source, in any combination, which would be appreciated by those of skill in the art. It is to be understood that the thruster component 460 may not only direct the flow of liquid circulating throughout the system 400, but also may increase the liquid velocity to flow accelerated liquid through the alteration section 420.

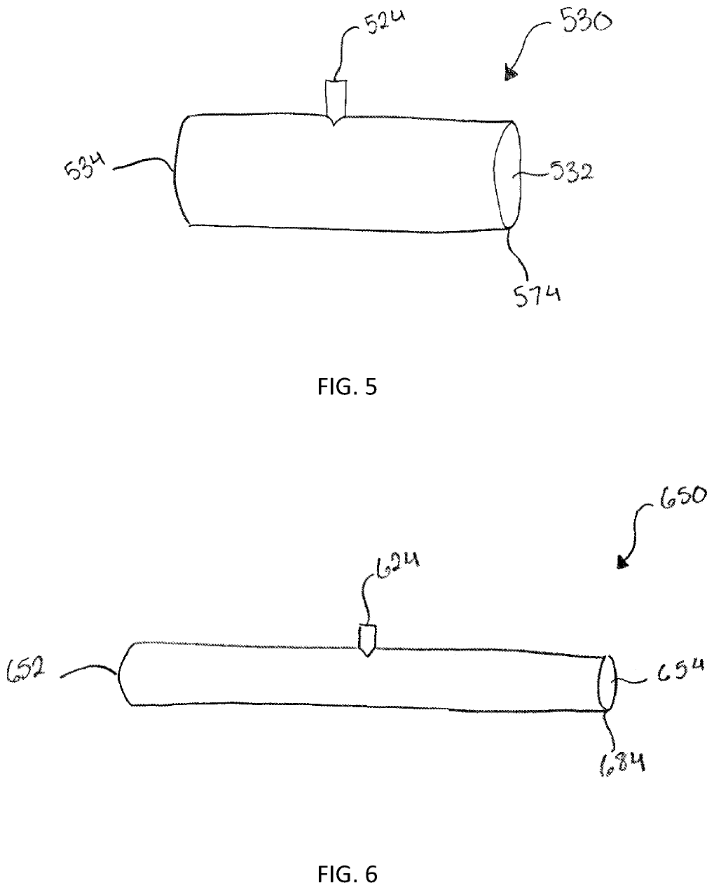

Referring now to FIG. 5, an illustrative flow section is depicted. An exemplary embodiment of the flow section 530 enabled by this disclosure configured in an open or a closed loop configuration will now be discussed, without limitation. In various embodiments, the flow section 530 can be employed in open and closed loop path configurations of a system of altering liquid flow properties, such as those shown in FIGS. 3 and 4. The flow section 530 may include an origin flow section end 532 and an exit flow section end 534. The flow section 530 may further include a first pathway with a first pathway cross-sectional area 574. In some embodiments, the flow section 530 may additionally include an air vent 524, which may be substantially sealed to any portion of the flow section 530.

The flow section will now be discussed in greater detail. FIGS. 1, 2, 3, 4, 5, and 7 highlight an example of the flow section, which may also be shown in other figures.

In additional embodiments, the flow section 130, 230, 330, 430, 530, 730, 1530 may include an origin flow section end 232, 332, 532, and an exit flow section end 234, 334, 534. The flow section may facilitate the first flow pathway with a first pathway cross-sectional area 574, 1174. Sensor(s) may be placed to monitor parameters such as liquid velocity, pressure, and temperature.

In some embodiments, the flow section 130, 230, 330, 430, 530, 730, 1530 may include a high velocity chamber (HVC) in lieu of at least one thruster component 160, 260, 360, 460, 760, 1060, 1560, which may include a backflow gate that can be used to close the HVC for liquid filling. An air vent 524, 624, 724 may release air trapped in the HVC. Multiple thrusters may be inside of the HVC. A flow output can be discharged as liquid flow from the HVC. Sensors may monitor the HVC for parameters such as liquid velocity, flow rate and pressure.

The air vent will now be discussed in greater detail. FIGS. 5, 6, and 7 highlight an example of the air vent, which may also be shown in other figures.

In various embodiments, the air vent 524, 624, 724 may be placed virtually anywhere in the system 100, 200, 300, 400, 700, 1500, for example, in the flow section 130, 230, 330, 430, 530, 730, 1530. In other embodiments, the air vent 524, 624, 724 may be placed in the conveyance section 150, 250, 350, 450, 650, 750, 1550. The air vent 524, 624, 724 may be configured to release trapped air inside of the system 100, 200, 300, 400, 700, 1500. The air vent 524, 624, 724 may include a valve for the user to open and close the air vent 524, 624, 724, as needed. In at least one embodiment, the valve of the air vent 524, 624, 724 may comprise a ball valve, globe valve, butterfly valve, needle valve, poppet valve, spool valve, and/or any other applicable valve, in any combination, configured to substantially open and close the air vent 524, 624, 724. The air vent may also house a check valve which may ensure that the air flows in only one direction. In various embodiments, the air vent 524, 624, 724 may be comprised of cast iron, galvanized steel, galvanized wrought iron, copper, brass, PVC, ABS, and/or any other applicable material, in any combination, configured to functionally operate as described.

Referring now to FIG. 6, a conveyance section 650 is depicted. An exemplary embodiment of the conveyance section 650 enabled by this disclosure configured in an open or a closed loop configuration will now be discussed, without limitation. In various embodiments, the conveyance section 650 can be employed in open and closed loop path configurations of a system of altering liquid flow properties, such as those shown in FIGS. 3 and 4. The conveyance section 650 may include a origin conveyance section end 652 and an exit conveyance section end 654. The conveyance section 650 may further include a second pathway with a second pathway cross-sectional area 684. In some embodiments, the conveyance section 650 may additionally include an air vent 624, which may be substantially sealed to virtually any portion of the conveyance section 650.

The conveyance section will now be discussed in greater detail. FIGS. 1, 2, 3, 4, 6, and 7 highlight examples of the conveyance section, which may also be shown in other figures.

The conveyance section 150, 250, 350, 450, 650, 750, 1550 may include an origin conveyance section end 252, 352, 652, and an exit conveyance section end 254, 354, 654. The conveyance section 150, 250, 350, 450, 650, 750, 1550 may be a part of the second pathway 180, 280, 780, 1180, with second pathway cross-sectional area 684, 1184. Sensor(s) may be placed to monitor parameters such as liquid velocity, pressure, and temperature. An air vent 524, 624, 724 may release trapped air inside of the conveyance section 150, 250, 350, 450, 650, 750, 1550.

In some embodiments, the conveyance section 150, 250, 350, 450, 650, 750, 1550 may include a high velocity chamber (HVC) in lieu of at least one thruster component 160, 260, 360, 460, 760, 1060, 1560, which may include a backflow gate that can be used to close the HVC for liquid filling. An air vent 524, 624, 724 may release air trapped in the HVC. Multiple turbines may be at least partially located inside of the HVC. A flow output can be discharged as liquid flow from the HVC. Sensors may monitor the HVC for parameters such as liquid velocity, flow rate, and pressure.

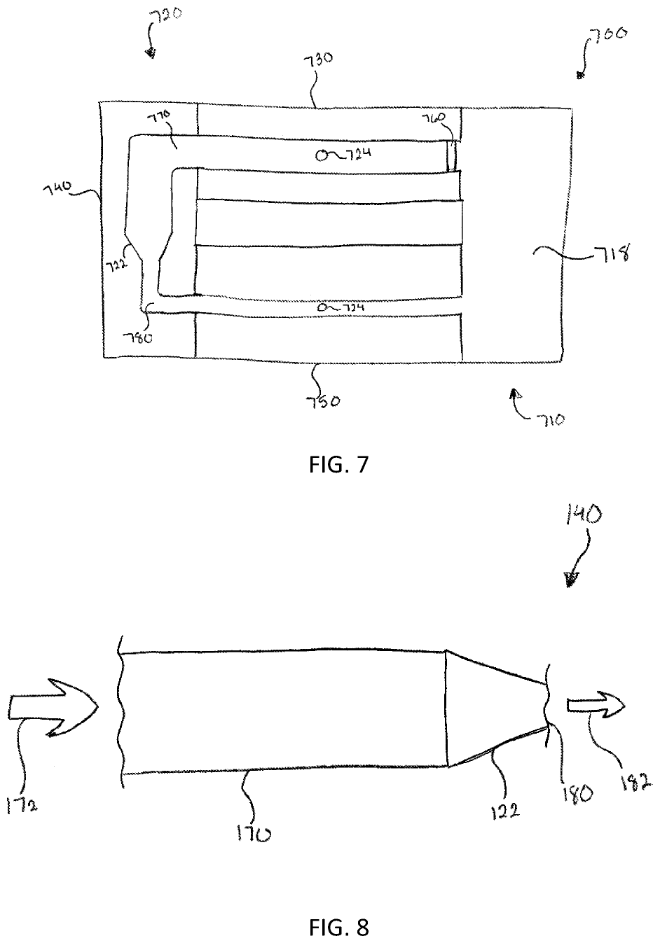

Referring now to FIG. 7, an exemplary system for altering flow properties of liquids is shown. An exemplary embodiment of system 700 enabled by this disclosure configured in a closed-loop configuration will now be discussed, without limitation. In this exemplary embodiment, the system may be fully enclosed.

In general, the system may comprise a basin section 710 and an alteration section 720. The liquid may generally flow from the basin section 710, through the alteration section, where the flow rate may be altered to a first flow rate.

In one illustrative embodiment, the flow of the liquid may begin from a reservoir 718 of the basin section 710. For example, the liquid may flow from the basin section 710 into the flow section 730. A thruster component 760 may be located in the alteration section 720, for example, at the flow section 730. At least part of the first pathway 770 may be located in the flow section 730. In one illustrative embodiment, the thruster component 760 may be located in the flow section 730 to accelerate liquid through the first pathway 770. The liquid may be accelerated by the thruster component 760 and pass through the flow section 730. In some embodiments, the flow section 730 may further comprise an air vent, for example, to vent unwanted gases from the system 700.

The flow of the liquid from the flow section 730 may be received by the turbine section 740. The flow section 730 may be attached to the turbine section 740. The first pathway 770 may continue from the flow section 730 and through at least part of the turbine section 740. The turbine section 740 may further include a reduction section 722. The liquid may continue to flow along the first pathway 770 until being received by the reduction section 722. The reduction section 722 may change the size of a pathway cross-sectional area, for example, by decreasing the first pathway 770 to a second pathway 780. The turbine section 740 may further include another pathway, for example, the second pathway 780. Part of the turbine section 740 may include part of the second pathway 780. The second pathway 780 may guide liquid through the turbine section 740.

The flow of the liquid from the turbine section 740 may be received by the conveyance section 750. The turbine section 740 may be substantially sealed to the conveyance section 750. Part of the second pathway 780 may be located in the conveyance section 750. The liquid may flow through the second pathway 780 of the conveyance section 750. In some embodiments, the conveyance section 750 may further comprise an air vent 724, for example, to vent unwanted gases from the system 700. The liquid may be received by the basin section 710, for example, in the reservoir 718.

Referring now to FIG. 8, a turbine section is depicted. In some embodiments, the turbine section depicted in FIG. 8 is the same section as depicted in FIG. 1. In various embodiments, and in lieu of only a conical configuration, the turbine section 140 can be employed in open and closed loop path configurations of a system to alter the flow properties of liquids, such as those shown in FIGS. 3 and 4.

In the exemplary embodiment of FIG. 8, the turbine section includes the first pathway 170, a reduction section 122, and a second pathway 180. The reduction section may allow for a change in size from one pathway to another pathway, for example, a decrease in size from the first pathway 170 to the second pathway 180. While the liquid travels through the reduction section 122, the flow properties of the liquid may change, for example, the liquid may enter the turbine section at a first flow rate 172 and leave the reduction section 122 at a second flow rate 182. The velocity change via the reduction section 122 may be manipulated. For example, the liquid may enter the reduction section 122 via the first pathway 170 and exit having a higher velocity at the exit point via the second pathway 180.

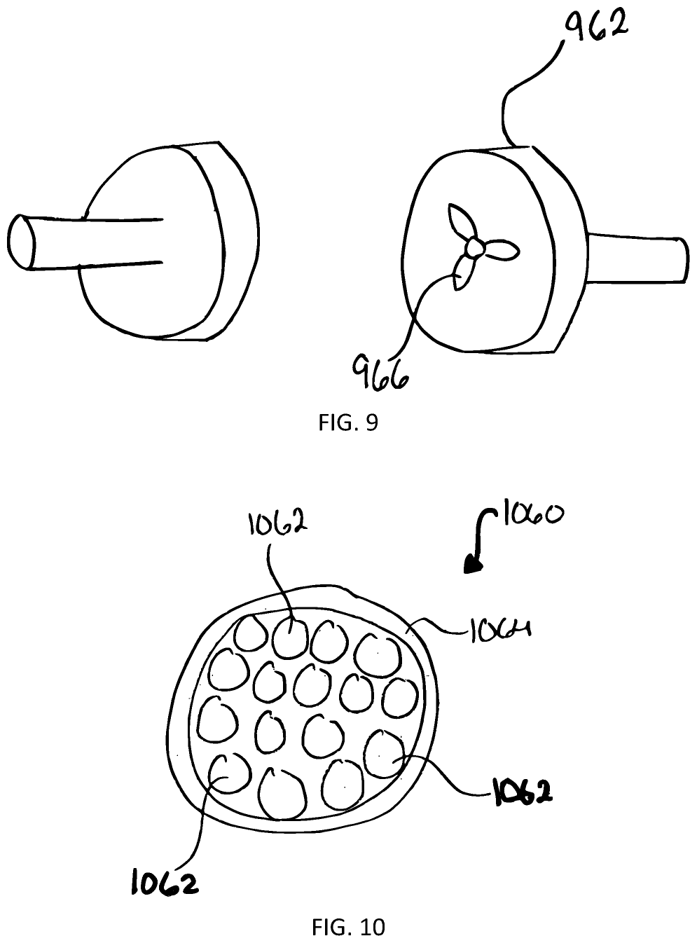

Referring now to FIG. 9, an exemplary set of thrusters having at least one thruster blade is depicted. In at least one embodiment, a system for altering flow properties may include at least one thruster 962 configured to be utilized to propel a liquid. Each thruster 962 may further comprise one or more thruster blades 966. The rotating process of the applicable rotor blades 966 may enable the Bernoulli Effect to occur, in which the pressure at the top of the rotor blades 966 may be less than the pressure at the bottom of the rotor blades generating a lifting force and resulting in simultaneous increased liquid speed and decreased internal application. Thus, the thruster 962 may be configured to operate in cooperation with at least one section in the system to increase the pressure of water entering the alteration section.

Referring now to FIG. 10, an illustrative thruster component is depicted. In various embodiments, a thruster component 1060 may house a plurality of thrusters 1062. The plurality of thrusters 1062 may be positioned within a common thruster output plane 1064. The common thruster output plane 1064 is a common plane of thrusters 1062 from which the liquid may be accelerated. The liquid accelerates approximately perpendicular to the common thruster output plane 1064. Within this common thruster output plane 1064, the liquid may enter through the thruster component 1060 and be accelerated throughout the system, for example, along the first pathway.

In some embodiments, a plurality of thrusters 1062 may be positioned within a frame, for example, a circular frame. As appreciated by those skilled in the art, the frame for which the thrusters may be located in may be configured with virtually any shape and/or size, in any combination, without limitation. Each or some of the thrusters 1062 may be the same or dissimilar to one another.

In various embodiments, and in lieu of only a conical configuration, a turbine section can be employed in open and closed loop path configurations of a system to alter the flow properties of liquids, such as those shown in FIGS. 3 and 4.

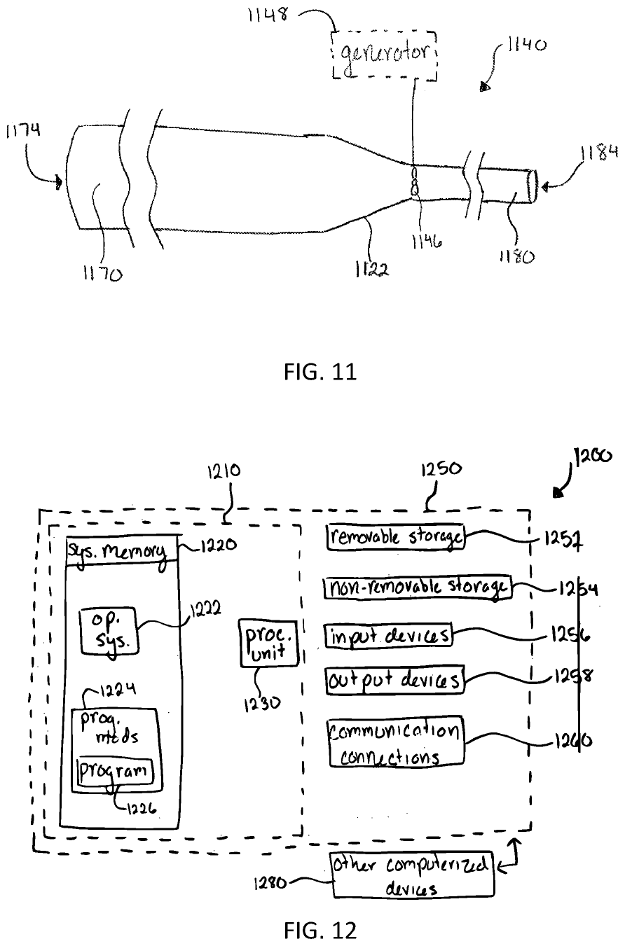

In the exemplary embodiment of FIG. 11, the turbine section 1140 may include a first pathway 1170, a reduction section 1122, and a second pathway 1180. The first pathway 1170 may have a first pathway cross-sectional area 1174, while the second pathway 1180 may have a second pathway cross-sectional area 1184. The reduction section 1122 may allow for a transition between one pathway to another pathway, for example, the reduction section 1122 may decrease the first pathway 1170 to the second pathway 1180. A liquid-driven turbine 1146 may be included in the pathway, for example, the liquid-driven turbine 1146 may be included at the origin of the second pathway 1180, near the reduction section 1122. The reduction section 1122 may alter the flow properties of the liquid, for example, accelerate the liquid from one flow rate to a different flow rate.

In another embodiment, the liquid-driven turbine 1146 of the turbine section 1140 may further be mechanically coupled to a generator 1148. The generator 1148 may be a location for which the mechanical energy from the liquid-driven turbine can be converted into electrical energy.

The liquid-driven turbine will now be discussed in greater detail. FIG. 11 highlights an example of the turbine, which may also be shown in other figures. In various embodiments, the turbine 1146 may be directly or indirectly upstream, in terms of liquid flow, of the reservoir. The turbine 1146 may also be directly or indirectly downstream, in terms of liquid flow, of the aforementioned flow section. Thus, the liquid-driven turbine 1146 may operate by using the liquid flow without the need for an external power source.

In at least one embodiment, the liquid-driven turbine 1146 may comprise at least one impeller composed of bronze, stainless steel, cast iron, aluminum, polycarbonate, composites, plastics, carbon fiber, and/or any other applicable material configured to sustain functionality for rotating parts of a centrifugal pump, compressor, and/or other machinery designed to move a liquid by rotation.

The impellers may be included in an open configuration or a closed configuration. In various embodiments, the configuration of the impellers may permit being controlled automatically or at least partially automatically by the computerized server based on at least a subset of data collected by the sensors or via a user operating on a user interface associated with the system, such as may be provided via the computing device. An example of data that may be detected by a sensor may include, without limitation, a threshold liquid pressure. The server may analyze the data, prompt the user, and suggest the user to change the configuration of the at least one impeller to adjust the components of the system to increase the efficacy of the system.

In various embodiments, the liquid-driven turbine 1146 may receive liquid from the reduction section 1122. The liquid-driven turbine 1146 may further include a turbine aperture configured to assist with the efficiency and overall functionality associated with the liquid-driven turbine 1146. In at least one example, the turbine aperture may advantageously prevent drag of the accelerated water that may otherwise potentially disrupt the water flow and reduce efficiency of the liquid-driven turbine 1146 and increase the operating temperature of the surrounding environment.

The generator will now be discussed in greater detail. FIG. 11, highlights an example of the generator, which may also be shown in other figures. In some embodiments, the generator 1184 may be a location where the mechanical energy from the liquid-driven turbine is converted into electrical energy, such as viewed in the configuration illustrated by the drawings. Those of skill in the art will appreciate that the illustrated configuration is one of many configurations of a system that allows water to flow to and from the reservoir and it is not intended to limit the scope of this disclosure in any way.

It is to be understood that the generator 1184 may comprise rotors, which may include rotor blades, coils, and/or other generator components known to one of ordinary skill in the art. As will be appreciated by skilled artisans, a generator 1184 may be configured to be driven by a rotational force, which may be provided by turbines and/or blades moved by passing water and/or another liquid. The liquid force may be applied to at least one rotor associated with the generator 1184, which may activate the generator 1184. In at least one embodiment, the liquid-driven turbine 1146 may provide the rotational force or any other applicable type of force to activate the generator 1184.

Still referring to FIG. 11, output of the generator 1184 may be facilitated by at least one supplemental power supply associated with the generator 1184, directly or indirectly, configured to increase the pressure of water and/or other liquids applied to the turbine 1184. In various embodiments, electricity output by the generator 1184 may go to a power grid and/or power storage.

In additional embodiments, a hydroelectrical power system may be used to assist with generation of electrical power from a hydroelectrical source. In this illustrative operation, a method of generating electrical power may benefit from aspects of the example hydroelectrical power system discussed throughout this disclosure. The hydroelectrical power system may include a primary power source and at least one liquid-driven turbine 1146. In one example of the method, the liquid-driven turbine 1146 may drive the power source. The method may include directing water to the liquid-driven turbine 1146 via a thruster component about a flow section. The thruster component may increase the velocity of the water and/or other liquid interfacing with the power generation components, for example, the generator 1148.

Referring now to FIG. 12, an illustrative computerized device will be discussed, without limitation. Various aspects and functions described in accord with the present disclosure may be implemented as hardware or software on at least one illustrative computerized device 1250 or other computerized devices 1280. There are many examples of illustrative computerized devices 1250 currently in use that may be suitable for implementing various aspects of the present disclosure. Some examples include, among others, network appliances, personal computers, workstations, mainframes, networked clients, servers, media servers, application servers, database servers and web servers. Other examples of illustrative computerized devices 1280 may include mobile computing devices, cellular phones, smartphones, tablets, video game devices, personal digital assistants, network equipment, devices involved in commerce such as point of sale equipment and systems, such as handheld scanners, magnetic stripe readers, bar code scanners and their associated illustrative computerized device 1250, among others. Additionally, aspects in accord with the present disclosure may be located on a single illustrative computerized device 1250 or may be distributed among at least one illustrative computerized device 1250 connected to at least one communication network.

For example, various aspects and functions may be distributed among at least one illustrative computerized device 1250 configured to provide a service to at least one client computer, or to perform an overall task as part of a distributed system. Additionally, aspects may be performed on a client-server or multi-tier system that includes components distributed among at least one server system that perform various functions. Thus, the disclosure is not limited to executing on any particular system or group of systems. Further, aspects may be implemented in software, hardware or firmware, or any combination thereof. Thus, aspects in accord with the present disclosure may be implemented within methods, acts, systems, system elements and components using a variety of hardware and software configurations, and the disclosure is not limited to any particular distributed architecture, network, or communication protocol.

FIG. 12 is a block diagram of a system 1200 including an example computing device and other computing devices. Consistent with the embodiments described herein, the aforementioned actions performed by the system 100 (as seen in FIG. 1) may be implemented in a computing device. Any suitable combination of hardware, software, or firmware may be used to implement the computing device 1210.

The aforementioned system, device, and processors are examples and other systems, devices, and processors may be included by the aforementioned computing device. Furthermore, the computing device 1210 may comprise an operating environment for the system. Processes and data related to the system may operate in other environments and are not limited to the computing device 1210.

A system 1200 consistent with an embodiment of the invention may include at least one computing device, such as the computing device 1210 of FIG. 12. In a basic configuration, a computing device 1210 may include at least one processing unit 1230 and system memory 1220. Depending on the configuration and type of computing device, system memory 1220 may comprise, but is not limited to, volatile (e.g., random-access memory (RAM)), non-volatile (e.g., read-only memory (ROM)), flash memory, or other combination or memory. System memory 1220 may include an operating system 1222, and at least one programming module 1224. An operating system 1222, for example, may be suitable for controlling the computing device's operation. In one embodiment, programming modules 1224 may include, for example, a program 1226 for executing the actions of a system. Furthermore, embodiments of the invention may be practiced in conjunction with a graphics library, other operating systems, or any other application program and is not limited to any particular application or system. This basic configuration is illustrated in FIG. 12 by those components within a dashed line 1210.

Computing devices may have additional features or functionality. For example, computing devices 1210 may also include additional data storage devices (removable and/or non-removable) such as, for example, magnetic disks, optical disks, or tape. Such additional storage is illustrated in FIG. 12 by a removable storage 1252 and a non-removable storage 1254.

Computer storage media may include volatile and nonvolatile, removable, and non-removable media implemented in any method or technology for storage of information, such as computer readable instructions, data structures, program modules, or other data. System memory 1220, removable storage 1252, and non-removable storage 1254 are computer storage media examples (i.e., memory storage) and provided without limitation. Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by a computing device 1210. Any such computer storage media may be part of a system 1200.

Computing devices 1210 may also have input device(s) 1256 such as a keyboard, a mouse, a pen, a sound input device, a camera, a touch input device, etc. Output device(s) 1258 such as a display, speakers, a printer, etc. may also be included. The aforementioned devices are only examples, and other devices may be added or substituted.

An illustrative computing device 1210 may also contain a communication connection 1260 that may allow a system to communicate with other computing devices 1280, such as over a network in a distributed computing environment, for example, an intranet or the Internet. A communication connection 1260 is one example of communication media. Communication media may typically be embodied by computer readable instructions, data structures, program modules, or other data in a modulated data signal, such as a carrier wave or other transport mechanism, and may include any information delivery media.

The term “modulated data signal” may describe a signal that has at least one characteristic set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 1220, including an operating system 1222. While executing on a processing unit 1230, programming modules 1224 (e.g., program 1226) may perform processes including, for example, at least one of the stages of a process. The aforementioned processes are examples, and the processing unit 1230 may perform other processes.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, liquidlike, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments enabled by this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While some embodiments of a computerized device on which aspects of the invention may be operated are described above, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

In various embodiments, the system may further include at least one sensor allocated on-site, for example, at the location of the hydroelectrical system. The sensors may be configured to collect data in real-time associated with conditions necessary to efficiently operate components of the system described throughout this disclosure. For example, conditions collected by the at least one sensor may include, without limitation, water level, pressure, temperature, humidity, barometric conditions, weather history, water flow, chemical balance, pH levels, oxygen reduction potential (ORP), calcium levels, salinity levels, tidal data, and/or any other applicable condition configured for operating water powered systems.

As described throughout this disclosure, the computing device may be and/or include a mobile phone, tablet, smart phone, desktop, laptop, wearable technology (smartwatch), or any other applicable device or system comprising at least a processor. Those of skill in the art will appreciate that the above list of computing devices is not intended to be limited. Skilled artisans will appreciate additional examples of computing devices to be included by this disclosure, after having the benefit of this disclosure.

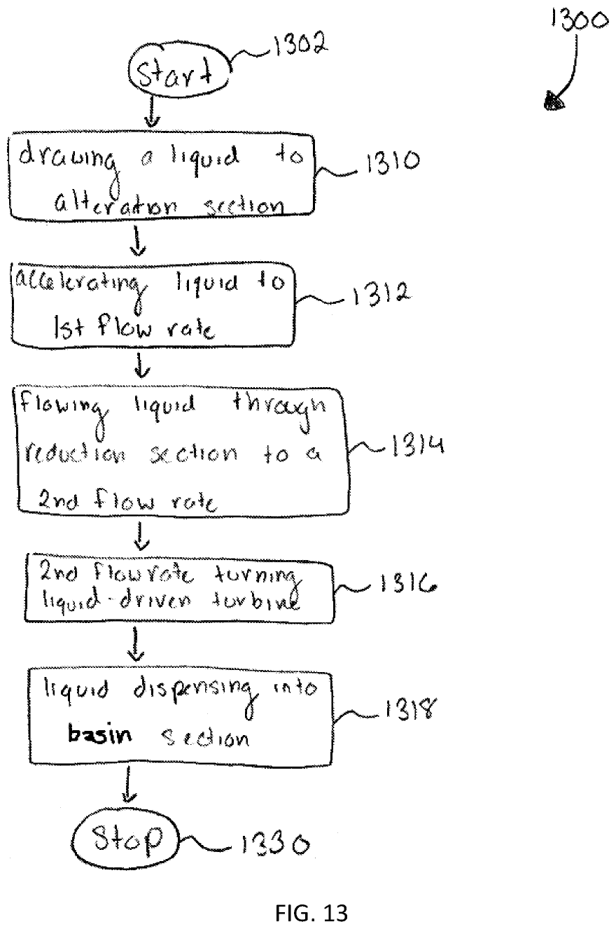

Referring now to flowchart 1300 of FIG. 13, an example method for the use of the system to alter the flow properties of liquids will be described, without limitation. This method comprises a basin section, an alteration section, a thruster component, a first flow rate, a reduction section, a second flow rate, and a liquid-driven turbine.

Starting at Block 1302, the method may include drawing a liquid to an alteration section (Block 1310). The liquid may then be accelerated to a first flow rate (Block 1312). The liquid may then be flowed through a reduction section, which may alter the flow rate of the liquid to a second flow rate (Block 1314). This method may further include using liquid flowing at the second flow rate to perform work, for example, turning a liquid-driven turbine (Block 1316). The liquid may then be dispensed into a basin section (Block 1318). In some cases, the liquid returned to the basin section after the operation of Block 1318 may again be drawn into an alteration section, as provided by Block 1310. The operation may then end at Block 1330.

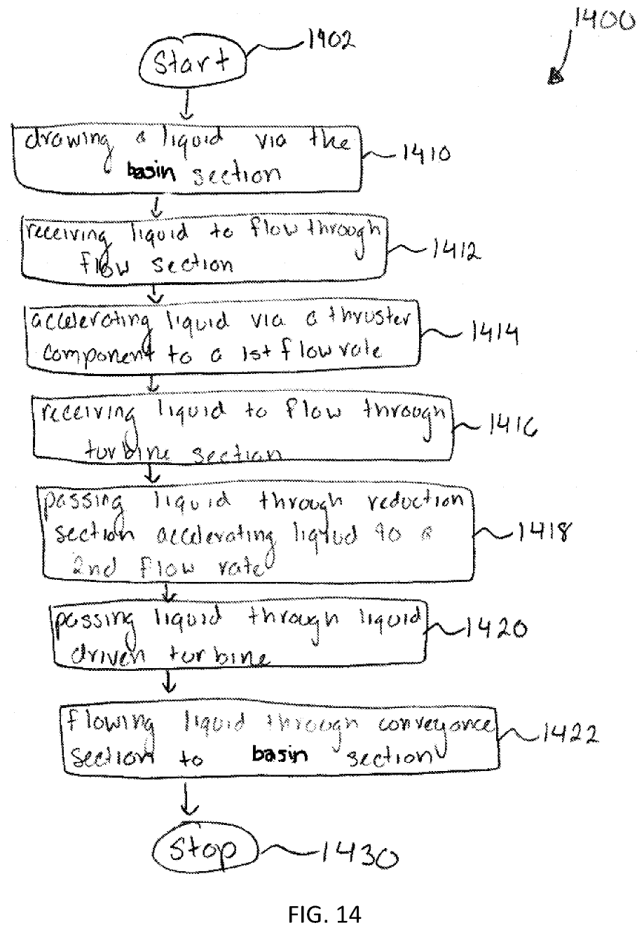

Referring now to flowchart 1400 of FIG. 14, an example method for the use of the system to alter the flow properties of liquids will be described, without limitation. This method comprises a basin section, a flow section, a turbine section, a conveyance section, a thruster component, a first flow rate, a reduction section, a second flow rate, and a liquid-driven turbine.

Starting at Block 1402, the method may include drawing a liquid to an alteration section via a basin section (Block 1410). The liquid may then be received by the flow section to flow through it (Block 1412). This method may further include accelerating the liquid to a first flow rate via a thruster component (Block 1414). The accelerated liquid may then flow to the turbine section (Block 1416). The accelerated liquid may then pass through the reduction section, through which the liquid may accelerate to a second flow rate (Block 1418). This method may further include using the accelerated liquid to perform work, for example, turning a liquid-driven turbine (Block 1420). The liquid may then be dispensed through a conveyance section into the basin section (Block 1422). In some cases, the liquid returned to the basin section after the operation of Block 1422 may again be drawn into the alteration section via the basin section, as provided by Block 1410. The operation may then end at Block 1430.

Skilled artisans will appreciate additional methods within the scope and spirit of the disclosure for performing the operations provided by the examples below after having the benefit of this disclosure. Such additional methods are intended to be included by this disclosure.

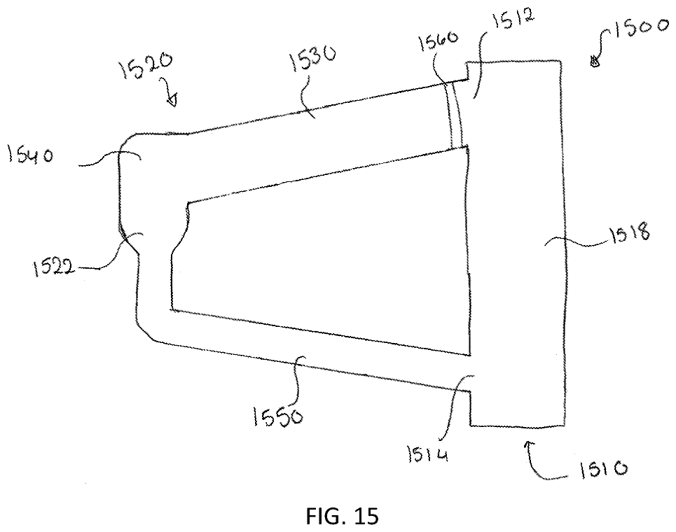

Referring now to FIG. 15, an exemplary system for altering flow properties of liquids is shown. An exemplary embodiment of system 1500 enabled by this disclosure configured in a closed-loop configuration will now be discussed, without limitation. In this exemplary embodiment, the system may induce a vertical change of height. In some embodiments, an angled feature and/or declining feature may accompany the change in height.

In general, the system may comprise a basin section 1510 and an alteration section 1520. The liquid may generally flow from the basin section 1510, through the alteration section 1520, where the flow rate may be altered. For example, thrusters and/or change in height may assist with altering the flow rate of the liquid passing through the alteration section.

In one illustrative embodiment, the flow of the liquid may begin from a reservoir 1518 of the basin section 1510. The origin basin section port 1512 may be located in a vertically higher plane than the exit basin section port 1514. The liquid may flow from the basin section 1510 into the flow section 1530. A thruster component 1560 may be located in the alteration section 1510, for example, at the flow section 1530. The liquid may be accelerated by the thruster component 1560 and pass through the flow section 1530. In some embodiments, the flow section 1530 may be positioned at a downward angle. The liquid may be accelerated due to a change of potential energy into kinetic energy and/or gravitational forces. In some embodiments, the flow section 1530 may further comprise an air vent, for example, to vent unwanted gases from the system.

The flow of the liquid from the flow section 1530 may be received by the turbine section 1540. The flow section 1530 may be attached to the turbine section 1540. The first pathway may continue from the flow section 1530 and through at least part of the turbine section 1540. The turbine section 1540 may be positioned at a downward angle. The liquid may be accelerated due to a change of potential energy. The turbine section 1540 may further include a reduction section 1522. The liquid may continue to flow along the first pathway until being received by the reduction section 1522. The reduction section 1522 may change the size of a pathway cross-sectional area, for example, by decreasing the first pathway to a second pathway. The turbine section 1540 may further include another pathway, for example, the second pathway. Part of the turbine section 1540 may include part of the second pathway. The second pathway, if provided, may guide liquid through the turbine section 1540.

The flow of the liquid from the turbine section 1540 may be received by the conveyance section 1550. The turbine section 1540 may be substantially sealed to the conveyance section 1550. Part of the second pathway may be located in the conveyance section 1550. The conveyance section 1550 may be positioned at a downward angle. The liquid may be accelerated due to a change of potential energy. The liquid may flow through the second pathway of the conveyance section 1550. In some embodiments, the conveyance section 1550 may further comprise an air vent, for example, to vent unwanted gases from the system 1500. The liquid may be received by the basin section 1510, for example, in the reservoir 1518, via the exit basin section port 1514. In various embodiments, the exit basin section port 1514 may be located on a plane vertically lower than the origin basin section port 1512.

In some embodiments, the system, for example, the alteration section 120, 220, 320, 420, 720, 1520 may be oriented at a different height. In various embodiments, the flow section 130, 230, 330, 430, 530, 730, 1530 may be located in a vertically higher plane than the conveyance section 150, 250, 350, 450, 650, 750, 1550. In some embodiments, the origin basin section port 212, 312, 1512, may be located in a vertically higher plane than the exit basin section port 214, 314, 1514. The alteration section 120, 220, 320, 420, 720, 1520 may exhibit a downward slope and/or decrease in height, for example, in the first pathway, 170, 270, 770, 1170, and second pathway, 180, 280, 780, 1180. The declining vertical angle of the alteration section 120, 220, 320, 420, 720, 1520 may assist in the gravity-based acceleration component of the liquid. For example, increasing the potential energy of the liquid may increase the mechanical energy generation from the liquid-driven turbine. The decrease in height of the alteration section 120, 220, 320, 420, 720, 1520, could be exhibited at virtually any angle, as would be appreciated by those of skill in the art. In some embodiments, the preferred decrease in height of the alteration section 120, 220, 320, 420, 720, 1520, would be between a 30%-60% decrease.

While various aspects have been described in the above disclosure, the description of this disclosure is intended to illustrate and not limit the scope of the invention. The invention is defined by the scope of the claims of a corresponding nonprovisional utility patent application and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the claims of a corresponding nonprovisional utility patent application.

What is claimed is:

1. A system for altering flow properties of liquids comprising:
a basin section to supply a liquid for the system comprising:
an origin basin section port, and
an exit basin section port located apart from the origin basin section port;
an alteration section to alter the flow properties comprising:
a flow section to receive the liquid from the basin section comprising:
an origin flow section end, and
an exit flow section end opposite to the origin flow section end;
a turbine section to receive the liquid from the flow section comprising:
an origin turbine section end, and
an exit turbine section end opposite to the origin turbine section end;
a conveyance section to receive the liquid from the turbine section comprising:
an origin conveyance section end, and
an exit conveyance section end opposite to the origin conveyance section end;
a thruster component comprising at least one thruster to accelerate the liquid;
a liquid-driven turbine through which at least part of the liquid passes; and
wherein the liquid that passes from the exit basin section port of the basin section is flowed through the alteration section and directed to the basin section via the origin basin section port.

2. The system for altering flow properties of liquids of claim 1:
wherein the exit flow section end of the flow section is substantially sealed to the origin turbine section end of the turbine section; and
wherein the exit turbine section end of the turbine section is substantially sealed to the origin conveyance section end of the conveyance section.

3. The system for altering flow properties of liquids of claim 1:
wherein the exit basin section port of the basin section is substantially sealed to the origin flow section end of the flow section, and
wherein the exit conveyance section end of the conveyance section is substantially sealed to the origin basin section port of the basin section.

4. The system for altering flow properties of liquids of claim 1, wherein the basin section provides at least one portion of ingress and/or egress to regulate at least part of the liquid accessible to the alteration section.

5. The system for altering flow properties of liquids of claim 1, wherein the basin section comprises:
a reservoir to receive the liquid via the origin basin section port, and
wherein the thruster component is operatively attached to the exit basin section port to draw the liquid via the reservoir and accelerate the liquid to enter the alteration section at a first flow rate.

6. The system for altering flow properties of liquids of claim 5, wherein the at least one thruster receives at least part of its power from an external power source to accelerate the liquid to the first flow rate.

7. The system for altering flow properties of liquids of claim 1:
wherein a first pathway having a first pathway cross-sectional area flows the liquid through the flow section at a first flow rate; and
wherein a second pathway having a second pathway cross-sectional area smaller than the first pathway cross-sectional area flows the liquid through the conveyance section at a second flow rate.

8. The system for altering flow properties of liquids of claim 1, wherein the thruster component is operatively attached to the origin flow section end of the flow section to draw the liquid via the basin section and accelerate the liquid through the alteration section at a first flow rate.

9. The system for altering flow properties of liquids of claim 1, further comprising:
a first pathway having a first pathway cross-sectional area terminating at a reduction section located within the turbine section through which the liquid flows at a first flow rate;
a second pathway having a second pathway cross-sectional area originating from the reduction section through which the liquid flows at a second flow rate;
wherein the first pathway cross-sectional area is reduced to the second pathway cross-sectional area by the reduction section such that the liquid is accelerated from the first flow rate to the second flow rate; and
wherein the reduction section is substantially sealed between the first pathway and the second pathway.

10. The system for altering flow properties of liquids of claim 9:
wherein the liquid-driven turbine is located inside the second pathway and attached to a generator; and
wherein the liquid-driven turbine is rotated by the liquid having the second flow rate to drive the generator.

11. The system for altering flow properties of liquids of claim 10, comprising:
an air vent located between the thruster component and the reduction section to release air trapped within the alteration section.

12. The system for altering flow properties of liquids of claim 1:
wherein the origin basin section port is positioned at a lower height than the exit basin section port; and
wherein at least part of the alteration section has a downward grade from the exit basin section port to the origin basin section port.

13. The system for altering flow properties of liquids of claim 1:
wherein the thruster component comprises a plurality of thrusters, each of which being aligned to a common thruster output plane; and
wherein the liquid that is accelerated by the plurality of thrusters is discharged approximately perpendicular to the common thruster output plane.

14. The system for altering flow properties of liquids of claim 1, wherein the basin section, the flow section, the turbine section, and the conveyance section are provided as a single continuous unit.

15. A liquid flow alteration system comprising:
a basin section to supply a liquid for the system comprising:
an origin basin section port, and
an exit basin section port located apart from the origin basin section port;
an alteration section to alter the flow properties comprising:
a flow section to receive the liquid from the basin section;
a turbine section to receive the liquid from the flow section;
a conveyance section to receive the liquid from the turbine section;
a thruster component comprising at least one thruster to accelerate the liquid;
a first tube having a first tube cross-sectional area flows the liquid through the flow section at a first flow rate; and
wherein a second tube having a second tube cross-sectional area smaller than the first tube cross-sectional area flows the liquid through the conveyance section at a second flow rate; and
wherein the liquid that passes from the exit basin section port of the basin section is flowed through the alteration section and directed to the basin section via the origin basin section port;

16. The liquid flow alteration system of claim 15, further comprising:
a liquid-driven turbine through which at least part of the liquid passes;
wherein the liquid-driven turbine is located inside the second tube and attached to a generator; and
wherein the liquid-driven turbine is rotated by the liquid having the second flow rate to drive the generator.

17. The liquid flow alteration system of claim 15:
wherein the thruster component comprises a plurality of thrusters, each of which being aligned to a common thruster output plane; and
wherein the liquid that is accelerated by the plurality of thrusters is discharged approximately perpendicular to the common thruster output plane.

18. A system for altering flow properties of liquids comprising:
a basin section to supply a liquid for the system comprising:
an origin basin section port, and
an exit basin section port located in a vertically lower plane from the origin basin section port;
an alteration section to alter the flow properties comprising:
a flow section to receive the liquid from the basin section comprising:
an origin flow section end, and
an exit flow section end opposite to the origin flow section end;
a turbine section to receive the liquid from the flow section comprising:
an origin turbine section end, and
an exit turbine section end opposite to the origin turbine section end;
a conveyance section to receive the liquid from the turbine section comprising:
an origin conveyance section end, and
an exit conveyance section end opposite to the origin conveyance section end;
wherein the alteration section is oriented having a downward slope;
a thruster component comprising at least one thruster to accelerate the liquid;
a liquid-driven turbine through which at least part of the liquid passes; and
wherein the liquid that passes from the exit basin section port of the basin section is flowed through the alteration section and directed to the basin section via the origin basin section port.

19. A method for altering flow properties of liquids comprising:
(a) drawing a liquid via a basin section to supply a liquid to an alteration section;
(b) altering the flow properties of the liquid passing through an alteration section comprising:
(i) receiving the liquid from the basin section to flow through a flow section,
(ii) receiving the liquid from the flow section to flow through a turbine section, and
(iii) receiving the liquid from the turbine section to flow through a conveyance section;
(c) accelerating the liquid via a thruster component comprising at least one thruster;
(d) passing at least part of the liquid through a liquid-driven turbine; and
wherein the liquid that passes from the exit basin section port of the basin section is flowed through the alteration section and directed to the basin section via the origin basin section port.

20. The method of claim 19:
wherein during operation of step (a), the liquid is flowed in a first pathway having a first pathway cross-sectional area at a first flow rate;
wherein before operation of step (d), the method further comprises reducing the first pathway cross-sectional area to the second pathway cross-sectional area by a reduction section such that the liquid is accelerated from the first flow rate to a second flow rate; and
wherein during operation of step (d), the liquid is passed over the liquid-driven turbine at the second flow rate.
